(19) United States
(12) Patent Application Publication
(10) Pub. No.: US 2007/0237254 A1
(43) Pub. Date: Oct. 11, 2007

(54) Configuring a device for wireless communication

(75) Inventor: Zhouyue Pi, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/400,310

(22) Filed: Apr. 10, 2006

(51) Int. Cl. H04L 1/02

(52) U.S. Cl. 375/267

(57) ABSTRACT

A method of configuring a device for a wireless communication, the method comprising the steps of: selecting a first combination of resources in relation to a first wireless communication in a first area involving a first device, and selecting one or more other combination(s) of resources in relation to one or more other wireless communication(s) in said first area that take priority over said first wireless communication; providing via a wireless interface said first device with information identifying said first combination of resources and said one or more other combination(s) of resources; and configuring the first device for said first wireless communication on the basis of said information identifying said first combination of resources and said one or more other combination(s) of resources.

The present invention relates to configuring a device for wireless communications. One embodiment of the invention relates to configuring a device for OFDM communication.

In an OFDM system, it is often advantageous to multiplex users in frequency domain to increase the system's multiplexing capability and to take advantage of frequency domain channel variation.

One technique of multiplexing a user's signal in frequency domain is frequency diversity transmission where the signal of one user is distributed across the bandwidth. Typically, a plurality of carrier frequencies (where each “carrier frequency” is typically a respective narrow band of frequencies) are allocated in a comb fashion or according to a frequency hopping pattern so that the user's signal is spread across the frequency domain. This technique can have the advantage of significantly reducing the probability that a user's signal suffers deep fade.

Another technique is frequency selectivity transmission where carrier frequencies (where each “carrier frequency” is typically a respective narrow band of frequencies) are allocated to the transmission of a user signal in a cluster fashion so that there is a good probability that at least some of the user signal is selectively transmitted at frequencies where the channel condition is favourable. This technique has the advantage that frequency domain scheduling gain can be realized.

It is an aim of the present invention to provide a technique for configuring a device for a wireless communication whereby conflicts with one or more other wireless transmission(s) in the same area can be avoided even where the one or more other wireless transmissions are allocated combinations of resources in a conflicting way, such as can be the case, for example, where some wireless communications are frequency diversity transmission and other wireless communications are frequency selectivity transmissions.

According to a first aspect of the present invention, there is provided a method of configuring a device for a wireless communication, the method comprising the steps of: selecting a first combination of resources in relation to a first wireless communication in a first area involving a first device, and selecting one or more other combination(s) of resources in relation to one or more other wireless communication(s) in said first area that take priority over said first wireless communication; providing via a wireless interface said first device with information identifying said first combination of resources and said one or more other combination(s) of resources; and configuring the first device for said first wireless communication on the basis of said information identifying said first combination of resources and said one or more other combination(s) of resources.

According to another aspect of the present invention, there is provided a device for configuring a transmitter and/or receiver for a wireless communication, wherein the device is arranged to: (a) receive information identifying a first combination of resources selected in relation to a first wireless communication in a first area and information identifying one or more other combination(s) of resources selected in relation to one or more other wireless communication(s) in said first area that take priority over said first wireless communication; and (b) configure a transmitter and/or receiver for said first wireless communication on the basis of said information identifying said first combination of resources and said one or more other combination(s) of resources

According to another aspect of the present invention, there is provided a wireless communications network, including: (i) a device for participating in a first wireless communication in a first area; (ii) a controller for selecting a first combination of resources in relation to said first wireless communication involving a first device, and selecting one or more other combination(s) of resources in relation to one or more other wireless communication(s) in said first area that take priority over said first wireless communication; and (iii) a transmitter for transmitting to said device information identifying said first combination of resources and said one or more other combination(s) of resources; and wherein said device is arranged to configure itself for said first wireless communication on the basis of said information identifying said first combination of resources and said one or more other combination(s) of resources.

According to another aspect of the present invention, there is provided a computer program product comprising program code means which when loaded into a computer controls the computer to configure a device for a first wireless communication in a first area on the basis of information identifying a first combination of resources selected in relation to said first wireless communication, and information identifying one or more other combination(s) of resources selected in relation to one or more other wireless communication(s) in said first area.

According to another aspect of the present invention, there is provided a controller for controlling the configuration of a device for a wireless communication, wherein the controller is arranged to: (a) select a first combination of resources in relation to a first wireless communication within a first area and involving a first device, and select one or more other combination(s) of resources in relation to one or more other wireless communication(s) within the same area and taking priority over the first wireless communication; and (b) to arrange transmission to the first device of information identifying both the first combination of resources and the one or more other combination(s) of resources.

According to another aspect of the present invention, a method of controlling the configuration of a device for a wireless communication, including the steps of: (a) selecting a first combination of resources in relation to a first wireless communication within a first area and involving a first device, and selecting one or more other combination(s) of resources in relation to one or more other wireless communication(s) within the same area and taking priority over the first wireless communication, and (b) arranging transmission to the first device of information identifying both the first combination of resources and the one or more other combination(s) of resources.

According to another aspect of the present invention, a computer program product comprising program code means which when loaded into a computer controls the computer to perform a method including the steps of: (a) selecting a first combination of resources in relation to a first wireless communication within a first area and involving a first device, and selecting one or more other combination(s) of resources in relation to one or more other wireless communication(s) within the same area and taking priority over the first wireless communication, and (b) arranging transmission to the first device of information identifying both the first combination of resources and the one or more other combination(s) of resources.

In one embodiment, the step of configuring the first device for said first wireless communication using selected resources from said first combination of resources so as to avoid any conflict between said first wireless communication and said one or more other wireless communication(s).

In one embodiment, said one or more other combination(s) of resources are selected from predetermined combinations of resources.

In one embodiment, said one or more other combination(s) of resources are selected from said predetermined combinations of resources according to a predetermined selection rule, and said step of providing said first device with information for identifying said first combination of resources and said one or more other combination(s) of resources involves specifying the final one of the one or more other predetermined combination(s) of resources selected in relation to said one or more other wireless communication(s), and wherein the first device determines the identity of the remaining one or more other predetermined combination(s) of resources selected in relation to said one or more other wireless communication(s) by reference to said predetermined selection rule.

In one embodiment, the first combination of resources is a first type of combination of resources, and the one or more other combination(s) of resources are each a different, second type of combination of resources.

In one embodiment, said first combination of resources includes a first combination of carrier frequencies, and said one or more other combination(s) of resources includes one or more other combination(s) of carrier frequencies, and including the step of determining at the first device whether or not the first combination of carrier frequencies and the one or more other combination(s) of carrier frequencies share any individual carrier frequencies.

In one embodiment, said first wireless communication is either one of a frequency diversity transmission or a frequency selectivity transmission, and said one or more other wireless communication(s) are each the other of a frequency diversity transmission and a frequency selectivity transmission.

In one embodiment, said first combination of carrier frequencies includes a plurality of predetermined groups of carrier frequencies selected according to a predetermined selection rule, and the first device determines the identity of the plurality of predetermined groups of carrier frequencies selected in relation to the first wireless transmission partly by reference to said predetermined rule of selecting said predetermined groups.

In one embodiment, said one or more other combinations(s) of carrier frequencies also include a plurality of predetermined groups of carrier frequencies selected according to a predetermined selection rule, and the first device determines the identity of the plurality of predetermined groups of carrier frequencies selected in relation to the one or more other wireless transmission(s) by reference to said predetermined rule for selecting said predetermined groups.

In one embodiment, the device for configuring a transmitter and/or receiver for a wireless communication is part of a handset.

In one embodiment, additional signalling and control information is used to multiplex the frequency diversity transmissions and the frequency selectivity transmissions in the same OFDM symbol.

One embodiment uses efficient control channel messages to enable frequency domain multiplexing of frequency diversity transmissions and frequency selectivity transmissions. The total resources consumed by one type of transmissions are broadcast to all the users in the system. In addition, the information about the resource allocation, as if there is no resource allocated to the other type of transmissions, is also transmitted to the intended user. Based on these two sets of information, each user can calculate the exact resource to be used for the communication in which it is involved.

An embodiment of the present invention is described hereunder, by way of example only, with reference to the accompanying drawings, in which:

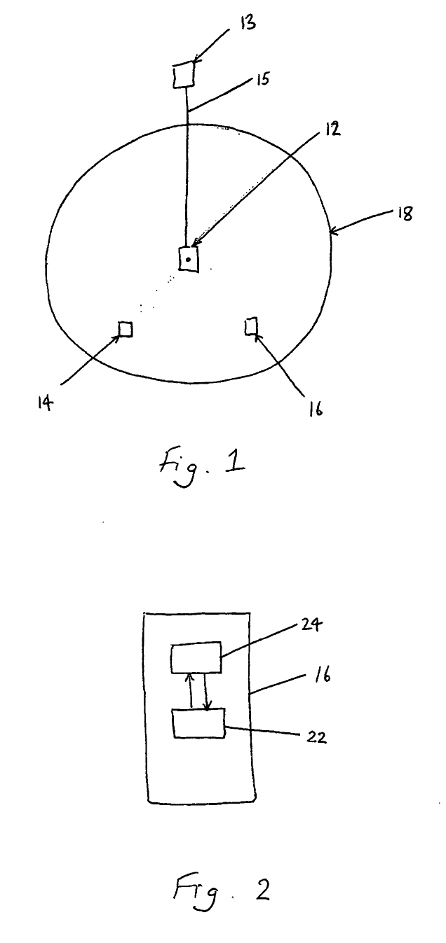

FIG. 1 is a schematic illustration of two user handsets in position for wireless communication with a common base station;

FIG. 2 is a schematic illustration of a handset according to an embodiment of a claimed invention;

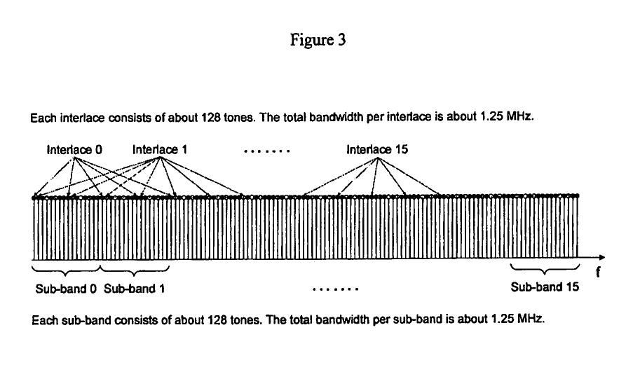

FIG. 3 illustrates an example of grouping individual carrier frequencies for frequency diversity interlaces and frequency selectivity sub-bands in an OFDM symbol;

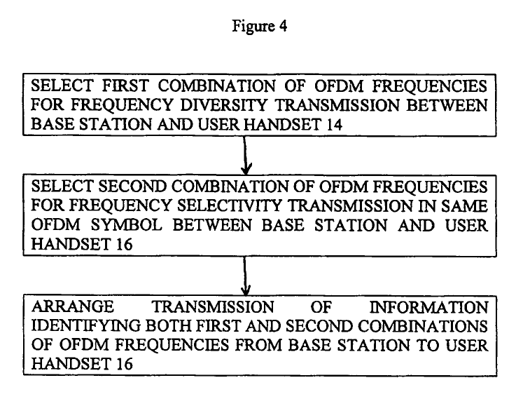

FIG. 4 illustrates a method according to an embodiment of the claimed invention; and

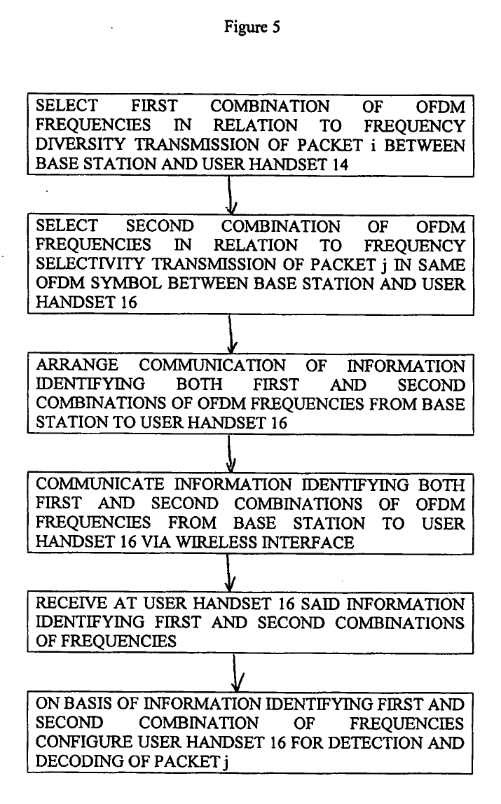

FIG. 5 also illustrates a method according to an embodiment of the claimed invention.

The embodiment of the invention is described, by way of example only, in the context of a 20 MHz OFDM system. The embodiment may also be applied to other type of systems and systems with different bandwidth.

Assuming 2048-point FFT (Fast Fourier Transform) is used, there are totally 2048 sub-carriers available. A set of sub-carriers is denoted as Ω={f ₀, f ₁, f ₂, . . . , f ₂₀₄₇}. For frequency diversity multiplexing, the available bandwidth is divided between 16 interlaces, with each interlace Iₙ={f ₙ, f ₙ₊₁₆, f ₙ₊₃₂, . . . , f ₙ₊₂₀₃₂}, n=0, 1, . . . , 15. Some of the interlaces may be allocated to pilot channel and control channels. One or more several interlaces may be allocated to one user. For frequency selectivity multiplexing, the available bandwidth is divided between 16 sub-bands, with each sub-band Bₘ={f ₁₂₈ₘ, f ₁₂₈ₘ₊₁, f ₁₂₈ₘ₊₂, . . . , f ₁₂₈ₘ₊₁₂₇}, m=0, 1, . . . , 15. One or several of these sub-bands may also be allocated to one user. These two frequency domain allocation schemes are shown in FIG. 3.

A frequency diversity transmission is allocated a set of frequency interlaces Iₙ with nεGᵢ. For example, Gᵢ={2, 10} means I₂ and I₁₀ are allocated to packet i. Denote the set of all sub-carrier allocated to packet i by

$${D}_{i} = D ( {G}_{i} ) = {⋃}_{n ∈ {G}_{i}} {I}_{n} .$$

Suppose there are N_{d} frequency diversity transmissions. The set of all sub-carriers allocated to frequency diversity transmissions is

$$D = {⋃}_{i = 1}^{{N}_{d}} {D}_{i} = {⋃}_{i = 1}^{{N}_{d}} {⋃}_{n ∈ {G}_{i}} {I}_{n} = {⋃}_{n ∈ Γ} {I}_{n} = D ( Γ ) , \\ where$$

$$Γ = {⋃}_{i = 1}^{{N}_{d}} {G}_{i}$$

is the set of all frequency interlaces allocated to frequency diversity transmissions.

Likewise, a frequency selectivity transmission is allocated a set of frequency sub-bands Bₘ with mεHⱼ. For example, Hⱼ={0, 1} means B₀ and B₁ are allocated to packet j. Denote the set of all sub-carriers allocated to packet j by

$${S}_{j} = S ( {H}_{j} ) = {⋃}_{n ∈ {H}_{j}} {B}_{m} .$$

Suppose there are Nₛ frequency selectivity transmissions. The set of all sub-carriers allocated to frequency selectivity transmissions is

$$S = {⋃}_{j = 1}^{{N}_{s}} {S}_{j} = {⋃}_{j = 1}^{{N}_{s}} {⋃}_{m ∈ {H}_{j}} {B}_{m} = {⋃}_{m ∈ Λ} {B}_{m} = S ( Λ ) , \\ where$$

$$Λ = {⋃}_{j = 1}^{{N}_{s}} {H}_{j}$$

is the set of all frequency sub-bands allocated to frequency selectivity transmissions.

When there are both frequency diversity transmission and frequency selectivity transmission in the same OFDM symbol, there will typically be intersection between any interlace with any sub-band, i.e., Iₙ∩Bₘ≠Ø, for any n and m. For example, suppose a frequency diversity transmission is allocated a set of interlaces G₁={2, 10}, i.e., D₁=D(G₁)=I₂∪I₁₀. Suppose a frequency selectivity transmission is allocated a set of sub-bands H₂={0, 1}, i.e., S₂=S(H₂)=B₀∪B₁. In this case, the intersection D₁∩S₂={f₂ f₁₀ . . . f₂₅₀} belongs to both the set D₁and the set S₂.

In order to enable the intended user to reliably detect and decode the packet, the resource allocation information is communicated to the intended user. For frequency diversity transmission of packet i, the information about set Gᵢ is communicated to the intended user(s). For frequency selectivity transmission of packet j, the information about set Hⱼ is communicated to the intended user(s). In addition, a rule is specified to resolve the conflict between frequency diversity transmissions and frequency selectivity transmissions.

The following technique is used to communicate Gᵢ and Hⱼ efficiently and resolve the conflict between Gᵢ, i=1 . . . , N_{d} and Hⱼ, j=1 . . . , Nₛ.

Frequency interlaces are allocated in a specified order. For example, frequency interlaces can be allocated with a bit-reversed-order (BRO) fashion, i.e., the frequency interlaces are allocated in the order of 0, 8, 4, 12, 2, 10, 6, 14, 1, 9, 5, 13, 3, 11, 7, 15. Only continuous allocation with the order specified is allowed. For example, an allocation of Gᵢ={2, 10, 6, 14} is allowed, but an allocation of Gᵢ={8, 4, 6, 14} is not allowed. If a packet is allocated Gᵢ={2, 10, 6, 14}, it is only necessary to communicate the indices of the first and last interlaces. In this example, it is only necessary to tell the intended user that the index of the first interlace is 2, and the index of the last interlace is 14. Alternatively, Gᵢ can be sufficiently accumulated by communicating only the index of the first interlace, and the cardinality of Gᵢ. In this example, it is only necessary to tell the intended user that the index of the first interlace is 2, and there are 4 interlaces assigned to his packet.

To efficiently communicate Hᵢ, frequency sub-bands are allocated in a specified order. For example, the frequency sub-bands may be allocated in the order of 0, 1, 2, 3, 4, 5, 6, 7, 8, 9, 10, 11, 12, 13, 14, and 15. Only continuous allocation with the order specified is allowed. For example, an allocation of Hᵢ={0, 1, 2, 3} is allowed, but an allocation of Hᵢ={0, 1, 5, 6} is not allowed. If a packet is allocated Hᵢ={0, 1, 2, 3}, it is only necessary to communicate the indices of the first and last sub-bands. In this example, it is only necessary to tell the intended user that the index of the first sub-band is 0, and the index of the last sub-band is 3. Alternatively, Hᵢ can be sufficiently communicated by communicating only the index of the first sub-band, and the cardinality of Hᵢ. In this example, it is only necessary to tell the intended user that the index of the first sub-band is 0, and there are 4 sub-bands assigned to his packet.

In addition, there is specified a rule to resolve conflict of resource allocation between frequency diversity transmissions and frequency selectivity transmissions.

In one example, frequency diversity transmissions are given higher priority than frequency selectivity transmissions. In other words, whenever there is conflict between frequency diversity allocation Gᵢ and frequency selectivity allocation Hⱼ, the intersection D(Gᵢ)∩S(Hⱼ)=Dᵢ∩Sⱼ is always assigned to the frequency diversity transmission. The actual frequency selectivity allocation is then Sⱼ\(Dᵢ∩Sᵢ). In order to enable an intended user of a frequency selectivity transmission to determine its actual resource allocation, information about the set Γ is also communicated to the intended user. Because frequency interlaces are allocated in order, it is only necessary to communicate the cardinality of Γ, which is denoted by Frequency Diversity Multiplexing Bandwidth (FDMB). For example, if FDMB=8, the set of interlaces used for frequency diversity transmission is Γ={0, 8, 4, 12, 2, 10, 6, 14}. Frequency interlaces I₀, I₈, I₄, I₁₂, I2, I₁₀, I₆, and I₁₄ are allocated to frequency diversity transmissions. With that information, a frequency selectivity transmission with resource assignment Hⱼ will be actually allocated sub-carriers S(Hⱼ)\(S(Hⱼ)∩D(Γ))=Sⱼ\(Sⱼ∩D).

In another example, frequency selectivity transmissions are given higher priority than frequency diversity transmissions in terms of frequency allocation. In other words, whenever there is conflict between frequency diversity allocation Gᵢ and frequency selectivity allocation Hⱼ, the intersection D(Gᵢ)∩S(Hⱼ)=Dᵢ∩Sⱼ is always assigned to the frequency selectivity transmission. The actual frequency diversity allocation is then Dᵢ\(Dᵢ∩Sⱼ). In order to enable an intended user of frequency diversity transmission to identify its actual resource allocation, we propose to also communicate the information about the set Λ. Because frequency sub-bands are allocated in order, we only need to communicate the cardinality of Λ, which is denoted by Frequency Selectivity Multiplexing Bandwidth (FSMB). For example, if FSMB=8, then Λ={0, 1, 2, 3, 4, 5, 6, 7}. Frequency sub-bands B₀, B₁, B₂, B₃, B₄, B₅, B₆, and B₇ are allocated to frequency selectivity transmissions. With that information, a frequency diversity transmission with resource assignment Gᵢ will be actually allocated sub-carriers D(Gᵢ)\(D(Gᵢ)∩S(Λ))=Dᵢ\(Dᵢ∩S).

The above-described embodiment enables frequency domain multiplexing of frequency diversity transmissions and frequency selectivity transmissions with relatively little overhead.

With reference to FIGS. 1 and 2, in one example, packet i is to be transmitted between a base station 12 (which functions as a BTS/Node B) and a first user handset 14, and packet j is to be transmitted in the same OFDM symbol between the same base station 12 and a different, second user handset 16 within the area 18 covered by the base station 12. A BSC/RNC 13 is connected by a land line 15 to the base station 12, and controls and manages the base station 12 as well as other base stations (not shown). A scheduler collated with the BSC/RNC 13 allocates a frequency diversity set Gᵢ to packet i, and allocates a frequency selectivity set Hⱼ to packet j. In this example, frequency diversity transmissions are given higher priority than frequency selectivity transmissions. Accordingly, if there is conflict between frequency diversity allocation Gᵢ and frequency selectivity allocation Hⱼ, the intersection is assigned to the frequency diversity transmission Gᵢ. The actual frequency selectivity allocation for packet j is then all of set Hⱼ other than the carrier frequencies also belonging to set Gᵢ. The BSC/RNC 13 instructs the base station 12 to communicate information identifying the set Gᵢ to the first user handset 14, and to communicate information identifying both the set Hⱼ and the set Gᵢ to the second user handset 16. The communication of such information can be done efficiently using the techniques described above. A microprocessor 22 located within second user handset 16 receives this information from the transmitter/receiver 24 of the second user handset 16 and determines on the basis of such information which carrier frequencies are to be used for the transmission of packet j. The microprocessor 22 then configures the transmitter/receiver 24 accordingly so as to reliably detect and decode packet j. FIG. 4 illustrates the method steps carried out by the BSC/RNC 13, and FIG. 5 illustrates the method steps carried out in turn by the BSC/RNC 13, base station 12 and handset 16.

Alternatively, the allocation of frequency diversity set Gᵢ to packet i, and frequency selectivity set Hⱼ to packet j could be carried out by a scheduler collated with the base station 12.

Appropriately adapted computer program code product may be used for implementing the functions of the controller associated with the base station and/or the microprocessor of the second user hand set. The program code product for providing the operation may be stored on and provided by means of a carrier medium such as a carrier disc, card or tape. A possibility is to download the program code product via a data network. Implementation may be provided with appropriate software in a server.

The concept can be implemented in ways other than those described in detail above without deviating from the scope of the invention. Examples of variations include, but are not limited to, the following:
A. The order of frequency interlaces can be configured, using signalling messages or other means.
B. The order of frequency sub-bands can be configured, using signalling messages or other means.
C. Some of the frequency interlaces may be reserved or used in other ways, either by other control channels, or by other data channels. For example, some interlaces or sub-bands may be allocated for pilot tones, or control information for forward link or reverse link. Some interlaces or sub-bands may be reserved for dedicated-channel type of communication. The reservation may also be changed by signalling messages or other means.
D. There may be multiple OFDM symbols in a slot. The frequency multiplexing and frequency allocation of these OFDM symbols may or may not be the same.
E. Only the frequency interlaces for frequency diversity transmissions are allocated in order whereas frequency sub-bands for frequency selectivity transmissions are allocated freely.
F. Only frequency sub-bands for frequency selectivity transmissions are allocated in order, whereas frequency interlaces for frequency diversity transmissions are allocated freely.
G. The information of either the total number of frequency interlaces, or the total number of frequency sub-bands is transmitted, or both.

All these different ways of operation can, for example, be configured through signalling messages.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

1. A method of configuring a device for a wireless communication, the method comprising the steps of:
selecting a first combination of resources in relation to a first wireless communication in a first area involving a first device, and selecting one or more other combination(s) of resources in relation to one or more other wireless communication(s) in said first area that take priority over said first wireless communication;
providing via a wireless interface said first device with information identifying said first combination of resources and said one or more other combination(s) of resources; and
configuring the first device for said first wireless communication on the basis of said information identifying said first combination of resources and said one or more other combination(s) of resources.

2. A method according to claim 1, including the step of configuring the first device for said first wireless communication using selected resources from said first combination of resources so as to avoid any conflict between said first wireless communication and said one or more other wireless communication(s).

3. A method according to claim 1, wherein said one or more other combination(s) of resources are selected from predetermined combinations of resources.

4. A method according to claim 3, wherein said one or more other combination(s) of resources are selected from said predetermined combinations of resources according to a predetermined selection rule.

5. A method according to claim 4, wherein said step of providing said first device with information for identifying said first combination of resources and said one or more other combination(s) of resources involves specifying the final one of the one or more other predetermined combination(s) of resources selected in relation to said one or more other wireless communication(s), and wherein the first device determines the identity of the remaining one or more other predetermined combination(s) of resources selected in relation to said one or more other wireless communication(s) by reference to said predetermined selection rule.

6. A method according to claim 1, wherein the first combination of resources is a first type of combination of resources, and the one or more other combination(s) of resources are each a different, second type of combination of resources.

7. A method according to claim 1, wherein said first combination of resources includes a first combination of carrier frequencies, and said one or more other combination(s) of resources includes one or more other combination(s) of carrier frequencies, and including the step of determining at the first device whether or not the first combination of carrier frequencies and the one or more other combination(s) of carrier frequencies share any individual carrier frequencies.

8. A method according to claim 7, wherein said first wireless communication is either one of a frequency diversity transmission or a frequency selectivity transmission, and said one or more other wireless communication(s) are each the other of a frequency diversity transmission and a frequency selectivity transmission.

9. A method according to claim 7, wherein said first combination of carrier frequencies includes a plurality of predetermined groups of carrier frequencies selected according to a predetermined selection rule.

10. A method according to claim 9, wherein the first device determines the identity of the plurality of predetermined groups of carrier frequencies selected in relation to the first wireless transmission partly by reference to said predetermined rule of selecting said predetermined groups.

11. A method according to claim 7, wherein said one or more other combinations(s) of carrier frequencies also include a plurality of predetermined groups of carrier frequencies selected according to a predetermined selection rule.

12. A method according to claim 11, wherein the first device determines the identity of the plurality of predetermined groups of carrier frequencies selected in relation to the one or more other wireless transmission(s) by reference to said predetermined rule for selecting said predetermined groups.

13. A device for configuring a transmitter and/or receiver for a wireless communication, wherein the device is arranged to: (a) receive information identifying a first combination of resources selected in relation to a first wireless communication in a first area and information identifying one or more other combination(s) of resources selected in relation to one or more other wireless communication(s) in said first area that take priority over said first wireless communication; and (b) configure a transmitter and/or receiver for said first wireless communication on the basis of said information identifying said first combination of resources and said one or more other combination(s) of resources.

14. A device according to claim 13, wherein said first combination of resources includes a first combination of carrier frequencies, and said one or more other combination(s) of resources includes one or more other combination(s) of carrier frequencies, and wherein the device is arranged to determine whether or not the first combination of carrier frequencies and the one or more other combination(s) of carrier frequencies share any individual carrier frequencies.

15. A device according to claim 14, wherein said first combination of carrier frequencies includes a plurality of predetermined groups of carrier frequencies selected according to a predetermined selection rule, and wherein the device is arranged to determine the identity of the plurality of predetermined groups of carrier frequencies selected in relation to the first wireless transmission partly by reference to said predetermined rule of selecting said predetermined groups.

16. A device according to claim 15, wherein said one or more other combinations(s) of carrier frequencies also include a plurality of predetermined groups of carrier frequencies selected according to a predetermined selection rule, and wherein the device is arranged to determine the identity of the plurality of predetermined groups of carrier frequencies selected in relation to the one or more other wireless transmission(s) by reference to said predetermined rule for selecting said predetermined groups.

17. A handset including a device for configuring a transmitter and/or receiver for a wireless communication, wherein the device is arranged to: (a) receive information identifying a first combination of resources selected in relation to a first wireless communication in a first area and information identifying one or more other combination(s) of resources selected in relation to one or more other wireless communication(s) in said first area that take priority over said first wireless communication; and (b) configure a transmitter and/or receiver for said first wireless communication on the basis of said information identifying said first combination of resources and said one or more other combination(s) of resources.

18. A handset according to claim 17, wherein said first combination of resources includes a first combination of carrier frequencies, and said one or more other combination(s) of resources includes one or more other combination(s) of carrier frequencies, and wherein the device is arranged to determine whether or not the first combination of carrier frequencies and the one or more other combination(s) of carrier frequencies share any individual carrier frequencies.

19. A handset according to claim 18, wherein said first combination of carrier frequencies includes a plurality of predetermined groups of carrier frequencies selected according to a predetermined selection rule, and wherein the device is arranged to determine the identity of the plurality of predetermined groups of carrier frequencies selected in relation to the first wireless transmission partly by reference to said predetermined rule of selecting said predetermined groups.

20. A handset according to claim 19, wherein said one or more other combinations(s) of carrier frequencies also include a plurality of predetermined groups of carrier frequencies selected according to a predetermined selection rule, and wherein the device is arranged to determine the identity of the plurality of predetermined groups of carrier frequencies selected in relation to the one or more other wireless transmission(s) by reference to said predetermined rule for selecting said predetermined groups.

21. A wireless communications network, including:
(i) a device for participating in a first wireless communication in a first area;
(ii) a controller for selecting a first combination of resources in relation to said first wireless communication involving a first device, and selecting one or more other combination(s) of resources in relation to one or more other wireless communication(s) in said first area that take priority over said first wireless communication; and
(iii) a transmitter for transmitting to said device information identifying said first combination of resources and said one or more other combination(s) of resources; and
wherein said device is arranged to configure itself for said first wireless communication on the basis of said information identifying said first combination of resources and said one or more other combination(s) of resources.

22. A network according to claim 21, wherein said first combination of resources includes a first combination of carrier frequencies, and said one or more other combination(s) of resources includes one or more other combination(s) of carrier frequencies, and wherein the device is arranged to determine whether or not the first combination of carrier frequencies and the one or more other combination(s) of carrier frequencies share any individual carrier frequencies.

23. A network according to claim 22, wherein said first combination of carrier frequencies includes a plurality of predetermined groups of carrier frequencies selected according to a predetermined selection rule, and wherein the device is arranged to determine the identity of the plurality of predetermined groups of carrier frequencies selected in relation to the first wireless transmission partly by reference to said predetermined rule of selecting said predetermined groups.

24. A network according to claim 23, wherein said one or more other combinations(s) of carrier frequencies also include a plurality of predetermined groups of carrier frequencies selected according to a predetermined selection rule, and wherein the device is arranged to determine the identity of the plurality of predetermined groups of carrier frequencies selected in relation to the one or more other wireless transmission(s) by reference to said predetermined rule for selecting said predetermined groups.

25. A computer program product comprising program code means which when loaded into a computer controls the computer to configure a device for a first wireless communication in a first area on the basis of information identifying a first combination of resources selected in relation to said first wireless communication, and information identifying one or more other combination(s) of resources selected in relation to one or more other wireless communication(s) in said first area.

26. A computer program product according to claim 25, wherein said first combination of resources includes a first combination of carrier frequencies, and said one or more other combination(s) of resources includes one or more other combination(s) of carrier frequencies, and wherein the computer program product comprises program code means which when loaded into a computer controls the computer to determine whether or not the first combination of carrier frequencies and the one or more other combination(s) of carrier frequencies share any individual carrier frequencies.

27. A computer program product according to claim 26, wherein said first combination of carrier frequencies includes a plurality of predetermined groups of carrier frequencies selected according to a predetermined selection rule, and wherein the computer program product comprises program code means which when loaded into a computer controls the computer to determine the identity of the plurality of predetermined groups of carrier frequencies selected in relation to the first wireless transmission partly by reference to said predetermined rule of selecting said predetermined groups.

28. A computer program product according to claim 27, wherein said one or more other combinations(s) of carrier frequencies also include a plurality of predetermined groups of carrier frequencies selected according to a predetermined selection rule, and wherein the computer program product comprises program code means which when loaded into a computer controls the computer to determine the identity of the plurality of predetermined groups of carrier frequencies selected in relation to the one or more other wireless transmission(s) by reference to said predetermined rule for selecting said predetermined groups.

29. A controller for controlling the configuration of a device for a wireless communication, wherein the controller is arranged to: (a) select a first combination of resources in relation to a first wireless communication within a first area and involving a first device, and select one or more other combination(s) of resources in relation to one or more other wireless communication(s) within the same area and taking priority over the first wireless communication; and (b) to arrange transmission to the first device of information identifying both the first combination of resources and the one or more other combination(s) of resources.

30. A controller according to claim 29, wherein said first combination of resources includes a first combination of carrier frequencies, and said one or more other combination(s) of resources includes one or more other combination(s) of carrier frequencies.

31. A controller according to claim 30, wherein said first combination of carrier frequencies includes a plurality of predetermined groups of carrier frequencies selected according to a predetermined selection rule.

32. A device according to claim 31, wherein said one or more other combinations(s) of carrier frequencies also include a plurality of predetermined groups of carrier frequencies selected according to a predetermined selection rule.

33. A method of controlling the configuration of a device for a wireless communication, including the steps of: (a) selecting a first combination of resources in relation to a first wireless communication within a first area and involving a first device, and selecting one or more other combination(s) of resources in relation to one or more other wireless communication(s) within the same area and taking priority over the first wireless communication, and (b) arranging transmission to the first device of information identifying both the first combination of resources and the one or more other combination(s) of resources.

34. A method according to claim 33, wherein said first combination of resources includes a first combination of carrier frequencies, and said one or more other combination(s) of resources includes one or more other combination(s) of carrier frequencies.

35. A method according to claim 34, wherein said first combination of carrier frequencies includes a plurality of predetermined groups of carrier frequencies selected according to a predetermined selection rule.

36. A device according to claim 35, wherein said one or more other combinations(s) of carrier frequencies also include a plurality of predetermined groups of carrier frequencies selected according to a predetermined selection rule.

37. A computer program product comprising program code means which when loaded into a computer controls the computer to perform a method including the steps of: (a) selecting a first combination of resources in relation to a first wireless communication within a first area and involving a first device, and selecting one or more other combination(s) of resources in relation to one or more other wireless communication(s) within the same area and taking priority over the first wireless communication, and (b) arranging transmission to the first device of information identifying both the first combination of resources and the one or more other combination(s) of resources.

38. A computer program product according to claim 37, wherein said first combination of resources includes a first combination of carrier frequencies, and said one or more other combination(s) of resources includes one or more other combination(s) of carrier frequencies.

39. A computer program product according to claim 38, wherein said first combination of carrier frequencies includes a plurality of predetermined groups of carrier frequencies selected according to a predetermined selection rule.

40. A computer program product according to claim 39, wherein said one or more other combinations(s) of carrier frequencies also include a plurality of predetermined groups of carrier frequencies selected according to a predetermined selection rule.
